(19) United States
(12) Patent Application Publication
(10) Pub. No.: US 2025/0070612 A1
(43) Pub. Date: Feb. 27, 2025

(54) Terminal Box for Motor and Motor

(71) Applicant: Siemens Aktiengesellschaft, München (DE)

(72) Inventors: Ling Ling Zou, Nanjing (CN); Zi Yan Li, Nanjing (CN); Zhuang Xiong, Nanjing (CN); Zi Yan Yu, Nanjing (CN); Li Guang Zhang, Nanjing (CN)

(73) Assignee: Siemens Aktiengesellschaft, München (DE)

(21) Appl. No.: 18/722,190

(22) PCT Filed: Dec. 22, 2021
(86) PCT No.: PCT/CN2021/140559

§ 371 Date: Jun. 20, 2024

(51) Int. Cl. H02K 5/22

(52) U.S. Cl. CPC H02K 5/225

(57) ABSTRACT

Examples of the present disclosure provide a terminal box for motor and a motor. 1. A terminal box for a motor, the terminal box comprising:
a body defining space for a terminal block for connecting inner cables to outer cables;
a first mounting structure on the body matching a second mounting structure on a housing of a motor, wherein the body is turnable around an axis within a set angle when mounted on the second mounting structure; and
a first positioning structure on the body matching a second positioning structure on the housing, wherein the first positioning structure cooperates with the second positioning structure to lock the body against turning.

### CROSS-REFERENCE TO RELATED APPLICATIONS

This application is a U.S. National Stage Application of International Application No. PCT/CN2021/140559 filed Dec. 22, 2021, which designates the United States of America, the contents of which are hereby incorporated by reference in their entirety.

### TECHNICAL FIELD

The present disclosure relates to motor technologies. Various embodiments of the teachings herein include terminal boxes for a motor and motors.

### BACKGROUND

A terminal box on a motor provides room to connect inner cables and outer cables, and protect the connection part. There are inlet holes for outer cables to go through. A gland is used when assembling the cables to seal between the hole and the cable. Normally the cables include a power cable and an encoder cable.

Since the mounting position and condition are different for different users, the users have different demand for the position of inlet holes for cables. Currently there are some terminal boxes each of which have the same inlet holes on both sides of it, namely there are respectively a group of inlet holes, for instance, an inlet hole for power cable and an inlet hole for encoder cable, on both sides of the terminal box, so that the user can choose a side to let in the cables. In addition, there may be a protective cover for each hole. For example, for the terminal box with four inlet holes, there are four protective covers for the four inlet holes.

### SUMMARY

The teachings of the present disclosure include a terminal box for motor and a motor to fulfill any required position for cable mounting. As an example, some embodiments include a terminal box for a motor having: a terminal box body, to offer a room for a terminal block for connecting inner cables and outer cables; a first mounting structure, positioned on the terminal box body and matching with a second mounting structure of a housing of a motor; to make the terminal box body be turnable around an axis within a set angle when mounted on the second mounting structure; the terminal block is fixed on the housing; and a first positioning structure, positioned on the terminal box body and matching with a second positioning structure positioned on the housing, to cooperate with the second positioning structure to lock the terminal box body when it is not needed to turn the terminal box body.

In some embodiments, the first mounting structure is a first hole with at least partially circular arc edge positioned at the bottom of the terminal box body, and the second mounting structure is a first raised part with at least partially circular arc outer edge; the terminal box body can be turned around an axis of the first raised part; the terminal block is fixed on the housing inside the first raised part; or the first mounting structure includes a second raised part with at least partially circular arc outer edge and a second hole positioned in the second raised part, and the second mounting structure is a groove with at least partially circular arc inner edge; the terminal box body can be turned around an axis of the second raised part; the terminal block is fixed on a boss of the housing inside the groove.

In some embodiments, the first positioning structure includes a plurality of first slots arranged around the first hole or the second hole within a set angle at the bottom inside of the terminal box body; the second positioning structure includes a first positioning protrusion matching with each of the first slots; when the terminal box body is turned, the first positioning protrusion drops from a first slot into a next first slot under an external force.

In some embodiments, the second positioning structure is a U-shaped metal bracket including a bottom bracket and two side brackets, the bottom bracket is to be fixed on the housing inside the first raised part or the groove and the first positioning protrusion is positioned on the bottom bracket; the terminal box further includes a terminal box cover, to cover the terminal box body and press the two side brackets to make the first positioning protrusion be fixed in the slot when being fixed on the terminal box body.

In some embodiments, the second positioning structure includes a plurality of second slots arranged around the first raised part or the groove within a set angle; the first positioning structure comprises a second positioning protrusion positioned at the bottom outside of the terminal box body and matching with each of the second slots; when the terminal box body is turned, the second positioning protrusion drops from a second slot into a next second slot under an external force.

In some embodiments, each slot comprises a first slope part on at least one side of the slot, and the positioning protrusion comprises a second slope part on at least one side of the positioning protrusion; wherein the second slope part corresponds to the first slope part.

In some embodiments, the box further includes one group of inlet holes on side wall of the terminal box body.

In some embodiments, the one group of inlet holes includes an inlet hole for power cable and an inlet hole for encoder cable.

In some embodiments, the box further includes one group of protective covers corresponding to the one group of inlet holes. In some embodiments, a shape of the terminal box is round, square, rectangle, hexagon or octagonal.

As another example, some embodiments include a motor having: a housing comprising a second mounting structure; a second positioning structure positioned on the housing; a terminal block for connecting inner cables and outer cables, to be fixed on the housing; and the terminal box for a motor according to any one example mentioned herein.

Because the terminal box can be turned round an axis, then the terminal box with only one group of inlet holes may fulfill any required position for cable mounting. In addition, the coordination of the terminal box cover and the U shaped second positioning structure can fully lock the terminal box body when it is not needed to turn the terminal box body.

### BRIEF DESCRIPTION OF THE DRAWINGS

For a better understanding of the present disclosure, reference should be made to the Detailed Description below, in conjunction with the following drawings in which like reference numerals refer to corresponding parts throughout the figures.

FIG. 1 is a schematic diagram showing an 3D stereogram of a motor incorporating teachings of the present disclosure;

FIG. 2 is a schematic diagram showing an assembly exploded view of the motor shown in FIG. 1;

FIG. 3 is a schematic diagram showing a I-I part cutaway view of the motor shown in FIG. 1;

FIG. 4 is a schematic diagram showing a part top view of the motor shown in FIG. 1 with terminal box cover removed;

FIG. 5 is a schematic diagram showing a 3D stereogram of a second positioning structure in the motor shown in FIG. 1;

FIG. 6 is a schematic diagram showing an assembly relationship between the first positioning structure and the second positioning structure incorporating teachings of the present disclosure;

FIG. 7A is a schematic diagram showing an example of a first mounting structure incorporating teachings of the present disclosure;

FIG. 7B is a schematic diagram showing an example second mounting structure incorporating teachings of the present disclosure;

FIG. 8 is a schematic diagram showing an assembly relationship between the first positioning structure and the second positioning structure incorporating teachings of the present disclosure;

FIG. 9 is a 3D stereogram of an example motor incorporating teachings of the present disclosure; and

FIG. 10 is a 3D stereogram of an example motor incorporating teachings of the present disclosure.

The reference numerals are as follows:

| Reference numeral | Object |
|---|---|
| 1 | motor body |
| 2 | housing |
| 21 | round raised part |
| 22 | boss |
| 23 | U-shaped metal bracket |
| 231 | bottom bracket |
| 2311, 2312 | first positioning protrusions |
| 232, 233 | side brackets |
| 24 | second slots |
| 3 | terminal box |
| 31 | terminal box body |
| 32 | round hole |
| 33 | annular positioning structure |
| 331 | first slots |
| 34 | terminal box cover |
| 332 | second positioning protrusion |
| 351, 352 | inlet holes |
| 361, 362 | protect covers |
| 4 | terminal block |
| 51~53 | inner power cables |
| 54 | inner encoder cable |
| 61~63 | outer power cables |
| 64 | outer encoder cable |
| 7, 8 | screws |

### DETAILED DESCRIPTION

Typically, a conventional terminal box at best allows two positions for cable mounting, which cannot fulfill more positions required by the user. And more inlet holes lead to higher tooling cost, higher machining cost of the terminal box and more protective covers. Using a turnable terminal box with only one group of inlet holes, the user can turn the terminal box to make the inlet holes be located at a required position.

Reference will now be made in detail to examples, which are illustrated in the accompanying drawings. In the following detailed description, numerous specific details are set forth in order to provide a thorough understanding of the present disclosure. Also, the figures are illustrations of an example, in which assemblies shown in the figures are not necessarily essential for implementing the present disclosure. In other instances, well-known assemblies, components, and circuits have not been described in detail so as not to unnecessarily obscure aspects of the examples.

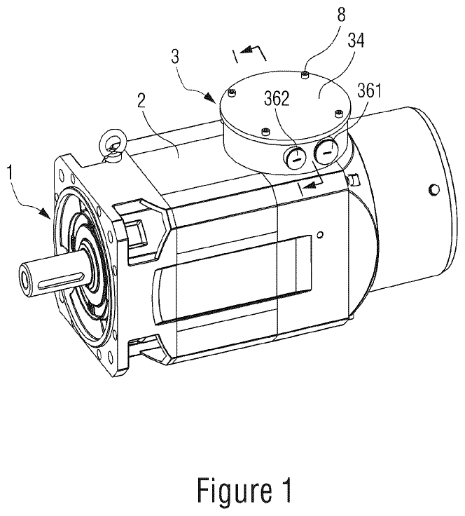

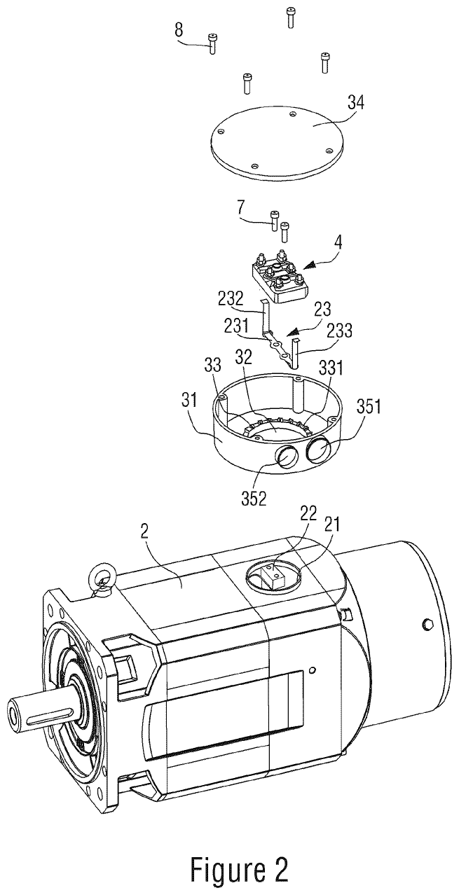

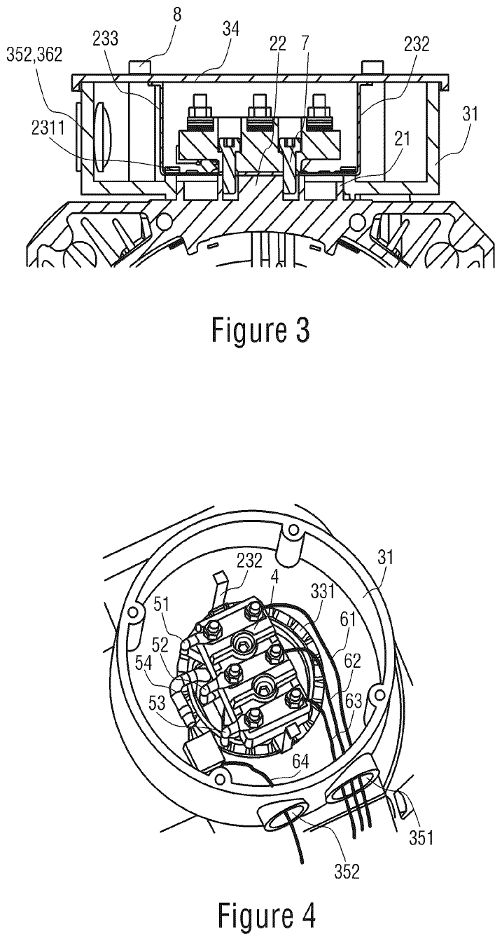

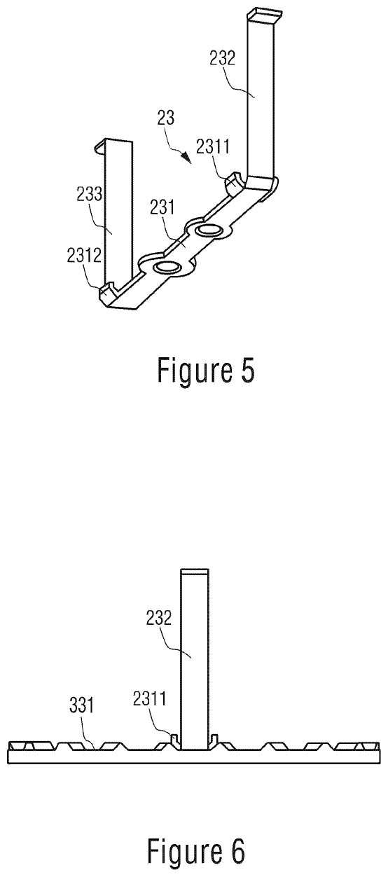

FIG. 1 is a schematic diagram showing a 3D stereogram of a motor incorporating teachings of the present disclosure. FIG. 2 is a schematic diagram showing an assembly exploded view of the motor shown in FIG. 1. FIG. 3 is a schematic diagram showing a I-I part cutaway view of the motor shown in FIG. 1. FIG. 4 is a schematic diagram showing a part top view of the motor shown in FIG. 1 with terminal box cover removed. FIG. 5 is a schematic diagram showing a 3D stereogram of a second positioning structure in the motor shown in FIG. 1. FIG. 6 is a schematic diagram showing an assembly relationship between the first positioning structure and the second positioning structure incorporating teachings of the present disclosure.

As shown in FIGS. 1 to 6, the motor may include a motor body 1, a housing 2, a terminal box 3 and a terminal block 4. The terminal box 3 includes a terminal box body 31, a first mounting structure, a first positioning structure, a terminal box cover 34, a group of inlet holes 351, 352, and group of protect covers 361, 362.

As shown in FIG. 4, the terminal box body 31 provides space for the terminal block 4 to connect inner cables 51˜54 and outer cables 61˜64. In the example, the inner cables 51˜54 may include inner power cables 51-53 and an inner encoder cable 54. Correspondingly, the outer cables 61˜64 may include outer power cables 61˜63 and an outer encoder cable 64. In other examples, the inner cables 51˜54 and outer cables 61˜64 may respectively include other cables.

The first mounting structure may be positioned on the terminal box body 31 and match with a second mounting structure of the housing 2, when the first mounting structure is mounted on the second mounting structure, the terminal box body 3 may be turnable around an axis within a set angle, for instance, 360°, 270°, 180°, 90°, or any other angle between 10° and 360°.

For instance, in the example, the first mounting structure may be a round hole 32 positioned at the bottom of the terminal box body 31. Correspondingly, the second mounting structure may be a round raised part 21 positioned on the housing 2. In the example, the terminal box body 3 may be turned around an axis of the round raised part 21 within 360°.

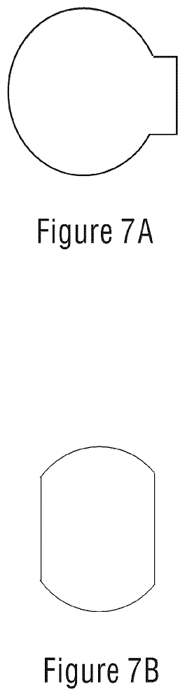

In other example, the first mounting structure may be not a round hole 32, as long as it is a first hole with at least partially circular arc edge. For instance, FIG. 7A is a schematic diagram showing a first mounting structure according to another example of the present disclosure. In other example, the second mounting structure may be not a round raised part 21, as long as it is a first raised part with at least partially circular arc outer edge. For instance, FIG. 7B is a schematic diagram showing a second mounting structure according to another example of the present disclosure.

In this case, the terminal block 4 may be fixed on the housing 2 inside the first raised part 21. As shown in FIG. 2, the terminal block 4 may be fixed on a first boss 22 of the housing 2 by two screws 7.

In addition, in yet other example, the first mounting structure may include a second raised part (not shown in figure) with at least partially circular arc outer edge and a second hole (not shown in figure) positioned in the second raised part, so that the terminal block 4 can be mounted on the housing 2 through the second hole. Correspondingly, the second mounting structure may be a groove (not shown in figure) with at least partially circular arc inner edge. In this case, the terminal block 4 may be fixed on the housing 2 inside the groove. For example, the terminal block 4 may be fixed on a second boss (not shown in figure) of the housing 2 by screws. The terminal box body 31 may be turned around an axis of the second raised part.

The first positioning structure may be positioned on the terminal box body 31 and match with a second positioning structure positioned on the housing 2, to cooperate with the second positioning structure to lock the terminal box body 31 when it is not needed to turn the terminal box body 31.

For instance, in the example, the first positioning structure may be an annular positioning structure 33 which includes a plurality of first slots 331 arranged around the round hole 32 or the second hole within 360° at the bottom inside of the terminal box body 31. In another example, the first positioning structure may be not an annular positioning structure 33, for instance, the first positioning structure may be an arc positioning structure 33 including a plurality of first slots arranged around the round hole 32 within set angle, for instance, any angle between 90° and 360°.

In the example, as shown in FIGS. 5 and 6, the second positioning structure may be a U-shaped metal bracket 23 including a bottom bracket 231 and two side brackets 232, 233. As shown in FIG. 2B, the bottom bracket 231 is to be fixed on the boss 22 by the two screws 7 and be located under the terminal block 4. The bottom bracket 231 includes two first positioning protrusions 2311, 2312 matching with each of the first slots 331. When the terminal box body 31 is turned, the first positioning protrusions 2311, 2312 drop from a first slot into a next first slot under an external force. In this case, the plurality of slots may be correspondingly arranged 4, 6, 8, 10, 12, 14, 16, 18, 20, or the like, slots.

In another example, the second positioning structure may be a L-shaped metal bracket comprising a short bottom bracket and a side bracket, and the short bottom bracket only include one positioning protrusion. In yet another example, the second positioning structure may be a leaf spring with a positioning protrusion matching with each of the first slots 331. In this case, the plurality of slots may be any number of slots arranged around the round hole 32.

In the example, each first slot 331 includes a first slope part on two sides of the slot, and each first positioning protrusion 2311, 2312 includes a second slope part on two sides of the positioning protrusion 2311, 2312, so that the terminal box body 31 may be turned clockwise or counterclockwise.

In other example, each first slot 331 may include a first slope part on only one side of the slot, and each first positioning protrusion 2311, 2312 may include a second slope part on the corresponding one side of the first positioning protrusion 2311, 2312, the second slope part corresponds to the first slope part. If the one side is clockwise side, the terminal box body 31 may be turned only clockwise; if the one side is counterclockwise side, the terminal box body 31 may be turned only counterclockwise.

The terminal box cover 34 is to cover the terminal box body, in the example shown in FIGS. 1 to 6, the terminal box cover 34 is further to press the two side brackets 232, 233 to make the first positioning protrusion s 2311, 2312 be fixed in the slot 331 when being fixed on the terminal box body 31 by four screws 8. In another example, the terminal box cover 34 may be not needed.

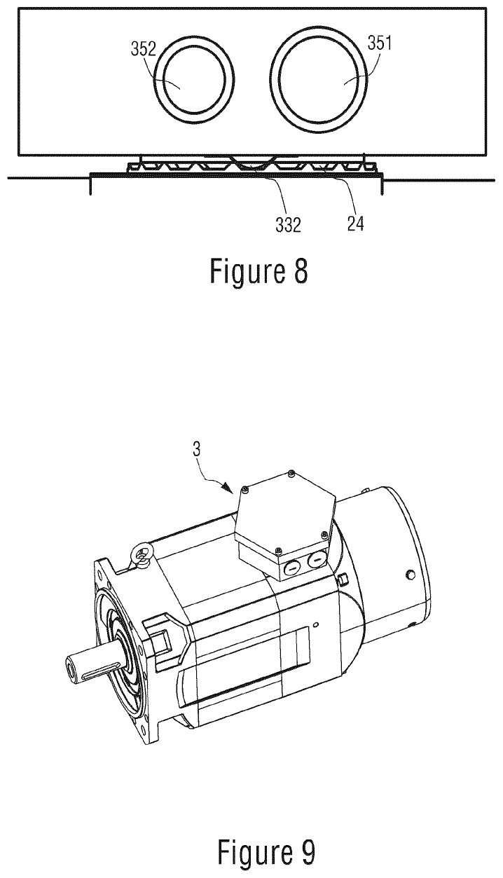

In addition, FIG. 8 is a schematic diagram showing an assembly relationship between the first positioning structure and the second positioning structure according to another example of the present disclosure. As shown in FIG. 8, in another example, the second positioning structure may include a plurality of second slots 24 arranged around the first raised part 21 or the groove within a set angle; correspondingly, the first positioning structure may include a second positioning protrusion 332 positioned at the bottom outside of the terminal box body 31 and matching with each of the second slots 24; when the terminal box body 31 is turned, the second positioning protrusion 332 drops from a second slot into a next second slot under an external force.

In the example, the group of inlet holes 351, 352 is positioned on side wall of the terminal box body 31. In the example, the one group of inlet holes 351, 352 includes an inlet hole for power cable 351 and an inlet hole for encoder cable 352.

In the example, the group of protect covers 361, 362 corresponds to the one group of inlet holes 351, 352 and is to cover the inlet holes 351, 352.

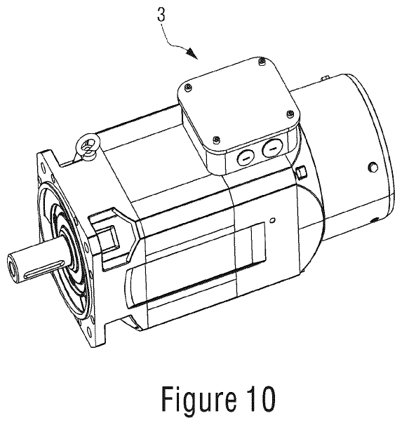

In the example, the shape of the terminal box 3 is round. In other examples, the shape of the terminal box may be other shape. For example, FIG. 9 is a 3D stereogram of a motor according to another example of the present disclosure. As shown in FIG. 9, the shape of the terminal box 3 may be hexagon. FIG. 10 is a 3D stereogram of a motor according to yet another example of the present disclosure. As shown in FIG. 10, the shape of the terminal box 3 may be square. In addition, the shape of the terminal box 3 may be rectangle, octagonal, or the like.

In the present disclosure, because the terminal box can be turned round an axis, then the terminal box with only one group of inlet holes may fulfill any required position for cable mounting.

In addition, the coordination of the terminal box cover and the U shaped second positioning structure can fully lock the terminal box body when it is not needed to turn the terminal box body.

It should be understood that, as used herein, unless the context clearly supports exceptions, the singular forms “a” (“a”, “an”, “the”) are intended to include the plural forms. It should also be understood that, “and/or” used herein is intended to include any and all possible combinations of one or more of the associated listed items.

The number of the embodiments of the present disclosure are only used for description, and do not represent the merits of the implementations.

The foregoing description, for purpose of explanation, has been described with reference to specific examples. However, the illustrative discussions above are not intended to be exhaustive or to limit the present disclosure to the precise forms disclosed. Many modifications and variations are possible in view of the above teachings. The examples were chosen and described in order to best explain the principles of the present disclosure and its practical applications, to thereby enable others skilled in the art to best utilize the present disclosure and various examples with various modifications as are suited to the particular use contemplated.

What is claimed is:

1. A terminal box for a motor, the terminal box comprising:
a body, defining space for a terminal block for connecting inner cables to outer cables;
a first mounting structure on the body matching a second mounting structure on a housing of a motor, wherein the body is turnable around an axis within a set angle when mounted on the second mounting structure; and
a first positioning structure on the body matching a second positioning structure on the housing, wherein the first positioning structure cooperates with the second positioning structure to lock the body against turning.

2. The terminal box for a motor according to claim 1, wherein:
the first mounting structure comprises a first hole with at least partially circular arc edge positioned at the bottom of the body;
the second mounting structure comprises a first raised part with at least partially circular arc outer edge;
the body can be turned around an axis of the first raised part; and
the terminal block is fixed on the housing inside the first raised part; or
the first mounting structure comprises a second raised part with at least partially circular arc outer edge and a second hole positioned in the second raised part, and the second mounting structure is a groove with at least partially circular arc inner edge;
the body can be turned around an axis of the second raised part; and
the terminal block is fixed on a boss of the housing inside the groove.

3. The terminal box for a motor according to claim 2, wherein:
the first positioning structure comprises a plurality of first slots arranged around the first hole or the second hole within a set angle at the bottom inside of the terminal box body;
the second positioning structure comprises a first positioning protrusion matching with each of the first slots; and
when the terminal box body is turned, the first positioning protrusion drops from a first slot into a next first slot under an external force.

4. The terminal box for a motor according to claim 3, wherein:
the second positioning structure comprises a U-shaped metal bracket with a bottom bracket and two side brackets, the bottom bracket is sized to be fixed on the housing inside the first raised part or the groove and the first positioning protrusion is positioned on the bottom bracket;
and the terminal box further comprises a terminal box cover, to cover the body and press the two side brackets to make the first positioning protrusion be fixed in the slot when being fixed on the body.

5. The terminal box for a motor according to claim 2, wherein:
the second positioning structure comprises a plurality of second slots arranged around the first raised part or the groove within a set angle;
the first positioning structure comprises a second positioning protrusion positioned at the bottom outside of the body and matching with each of the second slots; and
when the terminal box body is turned, the second positioning protrusion drops from a second slot into a next second slot under an external force.

6. The terminal box for a motor according to claim 3, wherein:
each slot comprises a first slope part on at least one side of the slot, and the positioning protrusion comprises a second slope part on at least one side of the positioning protrusion; and
the second slope part corresponds to the first slope part.

7. The terminal box for a motor according to claim 1, further comprising a group of inlet holes on side wall of the terminal box body.

8. The terminal box for a motor according to claim 7, wherein the one group of inlet holes comprises an inlet hole for power cable and an inlet hole for encoder cable.

9. The terminal box for a motor according to claim 7, further comprising a group of protective covers corresponding to the group of inlet holes.

10. The terminal box for a motor according to claim 1, wherein the terminal box is round, square, rectangle, hexagon or octagonal.

11. A motor comprising:
a housing comprising a mounting structure;
a positioning structure on the housing;
a terminal block for connecting inner cables to outer cables within a terminal box;
the terminal box having a body defining space for the terminal block;
a first mounting structure on the body matching a second mounting structure on a housing of a motor, wherein the body is turnable around an axis within a set angle when mounted on the second mounting structure; and
first positioning structure on the body matching a second positioning structure on the housing, wherein the first positioning structure cooperates with the second positioning structure to lock the body against turning.
